(19) United States
(12) Patent Application Publication
(10) Pub. No.: US 2026/0342568 A1
(43) Pub. Date: Oct. 29, 2026

(54) METHOD FOR PERFORMING AMORTIZED BOOTSTRAPPING OF CIPHERTEXTS IN LWE-BASED FULLY HOMOMORPHIC ENCRYPTION SCHEME

(71) Applicant: LG ELECTRONICS INC., Seoul (KR)

(72) Inventors: Syed Mahbub HAFIZ, Davis, CA (US); Gabrielle DE MICHELI, San Diego, CA (US); Thales Bandiera PAIVA, Sao Paulo (BR); Bahattin YILDIZ, Milpitas, CA (US); Marcos Antonio SIMPLICIO, JR., Sao Paulo (BR)

(73) Assignee: LG ELECTRONICS INC., Seoul (KR)

(21) Appl. No.: 19/639,068

(22) Filed: Apr. 3, 2026

Related U.S. Application Data
(60) Provisional application No. 63/783,269, filed on Apr. 4, 2025.

(51) Int. Cl. H04L 9/30; H04L 9/00

(52) U.S. Cl. CPC H04L 9/3093; H04L 9/008

(57) ABSTRACT

According to at least one embodiment, a computer-implemented method for performing amortized bootstrapping of ciphertexts in a learning-with-errors (LWE)-based fully homomorphic encryption (FHE) scheme using incomplete number theoretic transforms (NTTs) includes receiving a plurality of ciphertexts encrypted under a LWE-based scheme. The method further includes: packing the ciphertexts into a polynomial representation comprising a first polynomial component a(X) and a second polynomial component b(X) in a polynomial ring of degree N; and performing a homomorphic polynomial computation comprising computing a product of a(X) and a secret-key polynomial s(X). The product a(X) and s(X) is computed using an incomplete NTT computation that omits one or more transform layers relative to a complete NTT. The method further includes: recovering a product polynomial corresponding to the product of a(X) and s(X) by performing a multi-stage inverse NTT; and based on the recovered product polynomial, generating refreshed ciphertexts corresponding to the plurality of ciphertexts.

### CROSS-REFERENCE TO RELATED APPLICATION(S)

Pursuant to 35 U.S.C. § 119(e), this application claims the benefit of U.S. Provisional Patent Application No. 63/783,269 filed on Apr. 4, 2025, the contents of which are all hereby incorporated by reference herein in its entirety.

### BACKGROUND

Entities including governments and humanitarian organizations are increasingly concerned about protecting user data privacy. User data is vital for many solutions, particularly in training machine learning models. However, accessing sensitive user data while ensuring privacy has become essential and, often, legally required. Fully homomorphic encryption (FHE) directly addresses this need by enabling computations on encrypted data without needing to decrypt it first.

### SUMMARY

Aspects of this disclosure regard privacy-preserving data analysis, e.g., for user data collected through smart devices, such as smart TVs, refrigerators, and other home appliances. FHE offers a practical tool to achieve a goal of implementing privacy-preserving data analysis solutions.

For applications requiring exact and accurate data analysis, FHE schemes such as FHEW/TFHE (Fully Homomorphic Encryption Workshop/Torus FHE) are especially suitable. With reference to at least one embodiment, an amortized bootstrapping method disclosed herein enhances the efficiency and security of these schemes, making real-world deployment of FHE more achievable applications where exact and privacy-seeking computations are necessary.

According to at least one embodiment, a computer-implemented method is for performing amortized bootstrapping of ciphertexts in a learning-with-errors (LWE)-based fully homomorphic encryption (FHE) scheme using incomplete number theoretic transforms (NTTs). The method includes: receiving a plurality of ciphertexts encrypted under a LWE-based scheme; and packing the plurality of ciphertexts into a polynomial representation including a first polynomial component a(X) and a second polynomial component b(X) in a polynomial ring of degree N; and performing a homomorphic polynomial computation including computing a product of a(X) and a secret-key polynomial s(X). The product of a(X) and s(X) is computed using an incomplete NTT computation that omits one or more transform layers relative to a complete NTT. The method further includes: recovering a product polynomial corresponding to the product of a(X) and s(X) by performing a multi-stage inverse NTT including: a first stage that performs inverse transform operations and integrates multiplication of transform-domain coefficients corresponding to a(X) and s(X); and a second stage that completes recovery of the product polynomial. The method further includes: based on the recovered product polynomial, generating refreshed ciphertexts corresponding to the plurality of ciphertexts.

According to at least one embodiment, a non-transitory computer-readable medium stores instructions for performing amortized bootstrapping of ciphertexts in a learning-with-errors (LWE)-based fully homomorphic encryption (FHE) scheme using incomplete number theoretic transforms (NTTs). When executed by a processor of a computing device, the instructions cause the computing device to: receive a plurality of ciphertexts encrypted under a LWE-based scheme; pack the plurality of ciphertexts into a polynomial representation including a first polynomial component a(X) and a second polynomial component b(X) in a polynomial ring of degree N; and perform a homomorphic polynomial computation including computing a product of a(X) and a secret-key polynomial s(X). The product of a(X) and s(X) is computed using an incomplete NTT computation that omits one or more transform layers relative to a complete NTT. The instructions further cause the computing device to: recover a product polynomial corresponding to the product of a(X) and s(X) by performing a multi-stage inverse NTT including: a first stage that performs inverse transform operations and integrates multiplication of transform-domain coefficients corresponding to a(X) and s(X); and a second stage that completes recovery of the product polynomial; and based on the recovered product polynomial, generate refreshed ciphertexts corresponding to the plurality of ciphertexts.

According to at least one embodiment, a system is for performing amortized bootstrapping of ciphertexts in a learning-with-errors (LWE)-based fully homomorphic encryption (FHE) scheme using incomplete number theoretic transforms (NTTs). The system includes: one or more processors; and a memory storing instructions. When executed by the one or more processors, the instructions cause the system to: receive a plurality of ciphertexts encrypted under a LWE-based scheme; pack the plurality of ciphertexts into a polynomial representation including a first polynomial component a(X) and a second polynomial component b(X) in a polynomial ring of degree N; and perform a homomorphic polynomial computation including computing a product of a(X) and a secret-key polynomial s(X). The product of a(X) and s(X) is computed using an incomplete NTT computation that omits one or more transform layers relative to a complete NTT. The instructions further cause the computing device to: recover a product polynomial corresponding to the product of a(X) and s(X) by performing a multi-stage inverse NTT including: a first stage that performs inverse transform operations and integrates multiplication of transform-domain coefficients corresponding to a(X) and s(X); and a second stage that completes recovery of the product polynomial; and based on the recovered product polynomial, generate refreshed ciphertexts corresponding to the plurality of ciphertexts.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example computing system in accordance with some implementations.

FIG. 2 is a block diagram showing an example of a target computing device in accordance with some implementations.

FIG. 3 shows the overall shape of butterfly matrices for a particular configuration.

FIG. 4 shows the sparsity of butterfly matrices for a particular configuration.

FIG. 5 illustrates a flowchart of a method of performing amortized bootstrapping of ciphertexts in a learning-with-errors (LWE)-based fully homomorphic encryption (FHE) scheme using incomplete number theoretic transforms (NTTs), according to at least one embodiment.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Hereinafter, the embodiments disclosed in the present specification will be described in detail with reference to the accompanying drawings, the same or similar elements regardless of a reference numeral are denoted by the same reference numeral, and a duplicate description thereof will be omitted. In the following description, the terms “module” and “unit” for referring to elements are assigned and used exchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. The accompanying drawings are used to help easily explain various technical features, and it should be understood that the embodiments presented herein are not limited by the accompanying drawings. As such, the present disclosure should be construed to extend to any alterations, equivalents, and substitutes in addition to those which are particularly set out in the accompanying drawings.

The terminology used herein is used for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, implementations of the present disclosure will be described in detail with reference to the accompanying drawings. Like reference numerals designate like elements throughout the specification, and overlapping descriptions of the elements will not be provided.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

### INTRODUCTION

Fully homomorphic encryption (FHE) was first introduced in Gentry's seminal work and has since been extensively studied and improved both in terms of efficiency and security. Most of the known FHE schemes we have today are based on the RingLWE (Ring Learning With Errors) problem. Different strategies have been adopted to construct such schemes. In schemes such as BGV/BFV (Brakerski-Gentry-Vaikuntanathan/Brakerski-Fan-Vercauteren), ciphertexts encrypt vectors of values, and operations on ciphertexts (e.g., addition and multiplication) are performed componentwise using ring operations. Such schemes benefit from an amortized operation cost by simultaneously computing on all the entries of the vector ciphertext, however, at the cost of an expensive bootstrapping procedure and large parameters. In particular, the necessity for large parameters implies the need for stronger security assumptions, i.e., the security is based on worst-case lattice-based problems with superpolynomial approximation factors.

On the other hand, schemes such as FHEW/TFHE operate at the bit level, and ciphertexts are LWE encryptions with no additional ring structure. The ring structure is exploited in the context of programmable bootstrapping, where an encryption of f(m) is computed for any function ƒ and message m. By combining homomorphic LWE addition and programmable bootstrapping, FHEW/TFHE can evaluate any given circuit, meaning it can perform arbitrary homomorphic computations. In such schemes, the parameters are much smaller, leading to weaker security assumptions, i.e., the security is based on worst-case lattice-based problems with polynomial approximation factors, and bootstrapping is simpler and faster than for BGV/BFV.

When comparing the cost of bootstrapping procedures, the bottleneck operation for all of these schemes, the amortization that BGV/BFV benefits from by packing several messages into a large ring ciphertext, greatly outweighs its higher execution cost. In light of this observation, amortized bootstrapping algorithms, a way to refresh multiple ciphertexts at once, were proposed for FHEW/TFHE schemes to bridge the gap between these two strategies while preserving the security assumption that relies on worst-case lattice-based problems with polynomial approximation factors, similar to general lattice-based public key encryption schemes. Aspects of this disclosure continue the line of work that attempts to answer the question: can we bring amortized bootstrapping algorithms to be as efficient or more than their sequential counterparts?

An amortized method for FHEW-like ciphertexts was first proposed by Micciancio and Sorrell who showed that the cost of bootstrapping nciphertexts can be reduced from Õ(n) cryptographic operations to Õ(n_{ϵ}), for any ϵ>0. The main idea of their suggested method is to pack, say n LWE input ciphertexts, into a single RingLWE ciphertext and perform the bootstrapping operation over the one RingLWE ciphertext, thus amortizing the overall cost over n messages. The bottleneck operation of such a bootstrapping procedure is a homomorphic polynomial multiplication. One of the main challenges faced is the use of the RingGSW registers introduced in FHEW, which encrypt messages m in the exponent as monomials X^{m}. Given this structure, homomorphic addition is rather straightforward by using ciphertext multiplication. Still, other homomorphic operations that are required by fast polynomial multiplication algorithms, such as subtraction or multiplication by so-called twiddle factors, become much more challenging.

To address this, the original algorithm makes use of (a variant of) the Nussbaumer Transform to perform fast polynomial multiplication. While the proposed method offers a major asymptotic performance improvement, the algorithm is largely impractical due to a large constant 2^{O(1/ϵ)} hidden in the asymptotic notation.

In subsequent works, the Nussbaumer Transform is replaced with the much more practical Number Theoretic Transform (NTT), where the multiplication by twiddle factors is achieved using ring automorphisms. The use of ring automorphisms to perform homomorphic multiplication in the exponent, i.e., exponentiation by a constant, is not novel and was used for FHEW-related algorithms. The subsequent works then achieve similar asymptotic complexity but with a much smaller overhead, effectively reducing the complexity from 2^{O(1/ϵ)}·n^{1/ϵ} to (1/ϵ)·n^{1/ϵ}.

While the algorithms in the subsequent works follow the same structure, one centers its algorithm around RingLWE registers to perform the exponentiation, while the other extends the automorphism multiplication technique to work directly on RingGSW ciphertexts. Moreover, the latter work proposes a concrete C++ implementation of their algorithm, on which aspects of this disclosure are focused.

More recently, Liu and Wang introduced a new algebraic framework for batch homomorphic computation relying on the tensoring of three rings. This new framework improves the efficiency of amortized bootstrapping algorithms and achieves an amortized bootstrapping cost of Õ(1) homomorphic multiplication within a polynomial modulus. While the asymptotic cost is (almost) optimal, it is shown that the batch algorithm presented suffers from the same limitations, i.e., a very large overhead making the algorithm impractical for concrete parameters. More recently still, the work of Liu and Wang showed that the same asymptotic complexity can be attained while also obtaining an efficient algorithm for concrete parameters. This results from the use of a scheme-switching technique from FHEW/TFHE to BFV/BGV ciphertexts, enforcing, however, the use of a superpolynomial modulus, while the aforementioned schemes used polynomial moduli.

The first practical implementation of amortized bootstrapping by Guimarães uses the complete NTT to perform the polynomial multiplication needed by the homomorphic decryption. Their algorithm works in cyclotomic rings of the form [symbol] [X]/(X^{N}+1), where N is a power of two and p is a prime modulus. When p mod 2N=1, such rings are well-known to support fast NTT computations using FFT-like iterative algorithms. However, the authors notice that these cannot be used in the homomorphic setup because of the resulting large error growth, which can prevent correct decryption. The authors then propose a two-part NTT that provides a nice balance between performance and error growth. Unfortunately, their algorithm does not support the incomplete NTT formulation, which provides a more flexible set of parameters and sometimes even faster instantiations.

Aspects of this disclosure are directed toward improving upon the work of Guimarães, for example, by modifying their algorithm to incorporate the incomplete NTT formulation when performing the homomorphic polynomial multiplication. According to at least one embodiment, this involves a redesign of the homomorphic decryption algorithm to take into account a more complex multiplication in the NTT domain and a different two-part inverse NTT (INTT) algorithm. Remarkably, we show that our modified algorithm according to at least one embodiment has the same complexity as the original two-part NTT algorithm and hence does not introduce any additional overhead, at least until a specific level of incompleteness.

One important result of the incomplete NTT we exploit in our implementation is the much wider range of moduli that can be used. In particular, while the complete NTT in cyclotomic rings of the form [symbol] [X]/(X^{N}+1) requires p≡1 (mod 2N), the incomplete NTT with [symbol] layers less than the complete one only requires the less restrictive condition p≡1 (mod 2N/ [symbol] ). The latter can be achieved using smaller p, which are otherwise incompatible with complete NTT and will result in performance gains in the amortized bootstrapping algorithm that is propose with respect to at least one embodiment.

Another important aspect of bootstrapping algorithms to consider is the decryption failure rate (DFR). The additional choices of moduli mentioned above enable us to explore new trade-offs between DFR and performance. We thus provide a detailed analysis and description of the trade-offs we observe between the amortized cost of our algorithm according to at least one embodiment and the expected DFRs. We observe that while we can significantly improve upon the previous work and even observe better amortized cost than state-of-the-art TFHE-rs, this may come at the cost of higher DFRs. We then offer optimal trade-offs where we provide improved timings but where the DFRs are also in the range of acceptable values.

More precisely, aspects of this disclosure are directed to one or more of the following:

Algorithmic contribution: we introduce an improved amortized bootstrapping algorithm that exploits incompleteness in the homomorphic (inverse) NTT operations for free. More precisely, we propose an alternative two-part incomplete NTT that generalizes the two-part inverse NTT used in Guimarães while preserving the same algorithmic complexity. This generalization allows us to use a radix-2 incomplete NTT formulation and explore the much wider range of available moduli that can be used with no additional performance cost compared to the original algorithm.

Performance improvements and trade-offs: We present a detailed parameter exploration for our algorithm according to at least one embodiment, exploiting in particular the wider range of moduli values that the incomplete NTT allows for. We present experimental results with up to 2.14× improvement on execution time compared to Guimarães but also 1.12× improvement in time compared to state-of-the-art (sequential) TFHE-rs (ignoring higher DFRs).

We explore the existing trade-off between execution time and DFR for our algorithm and showcase examples where the execution time is better than Guimarães by 1.42× while also significantly improving the DFR (from 2⁻⁷ to 2⁻³⁹). We also show how the DFR can be made smaller than for TFHE-rs (2¹³¹<2⁻¹²¹) with a performance hit of 2.9×.

In this disclosure, we summarize relevant mathematical background material and introduce the standard encryption schemes and operations that will be relevant to embodiments described herein. We also provide more details on the notion of incompleteness in NTT and briefly describe the amortized bootstrapping algorithm given in Guimarães. Next, the disclosure focuses on our algorithm according to at least one embodiment, and we introduce our alternative two-part inverse incomplete NTT along with details on how we embed the base multiplication into the second part of the previous step. Next, we report on our implementation along with our experimental results and present the different improvements we obtain as a result of the use of incompleteness. We also compare our results with state-of-the-art sequential and amortized works.

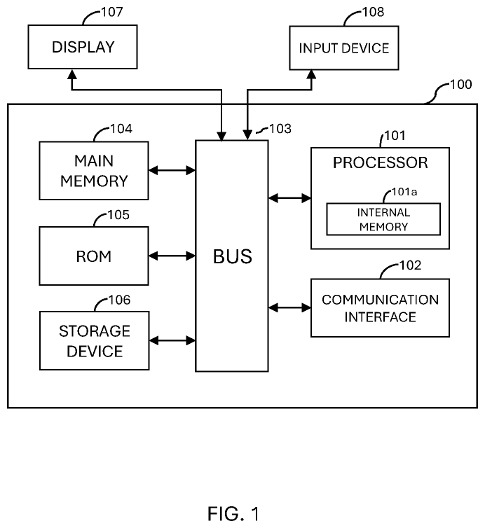

Referring now to FIG. 1, an illustration of an example computer 100 is provided which may be used to embody, implement, execute, or perform embodiments of the present disclosure. In selected embodiments, the computer 100 may include a bus 103 (or multiple buses) or other communication mechanism, a processor 101, processor internal memory 101a, main memory 104, read only memory (ROM) 105, one or more additional storage devices 106, and/or a communication interface 102, or the like or sub-combinations thereof. The embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

A bus 103 or other communication mechanism, including multiple such buses or mechanisms, may support communication of information within the computer 100. The processor 101 may be connected to the bus 103 and process information. In selected embodiments, the processor 101 may be a specialized or dedicated microprocessor configured to perform particular tasks in accordance with the features and aspects disclosed herein by executing machine-readable software code defining the particular tasks. In some embodiments, multiple processors 101 may be provided with each processing unit dedicated to a particular specialized task, such as graphics processing or artificial intelligence related processing.

Main memory 104 (e.g., random access memory—or RAM—or other dynamic storage device) may be connected to the bus 103 and store information and instructions to be executed by the processor 101. Processor 101 may also include internal memory 101a, such as CPU cache implemented by SRAM, for storing data used for executing instructions. Utilization of internal memory 101a may optimize data and memory management by reducing memory bandwidth usage with main memory 104. Although FIG. 1 depicts internal memory 101a as a component of processor 101, it will be understood that embodiments are included wherein internal memory 101a is a separate component apart from processor 101. Main memory 104 may also store temporary variables or other intermediate information during execution of such instructions.

ROM 105 or some other static storage device may be connected to a bus 103 and store static information and instructions for the processor 101. An additional storage device 106 (e.g., a magnetic disk, optical disk, memory card, or the like) may be connected to the bus 103. The main memory 104, ROM 105, and the additional storage device 106 may include a non-transitory computer-readable medium holding information, instructions, or some combination thereof, for example instructions that when executed by the processor 101, cause the computer 100 to perform one or more operations of a method as described herein. A communication interface 102 may also be connected to the bus 103. A communication interface 102 may provide or support two-way data communication between the computer 100 and one or more external devices (e.g., other devices contained within the computing environment).

In selected embodiments, the computer 100 may be connected (e.g., via a bus) to a display 107. The display 107 may use any suitable mechanism to communicate information to a user of the computer 100. For example, the display 107 may include or utilize a liquid crystal display (LCD), light emitting diode (LED) display, projector, or other display device to present information to a user of the computer 100 in a visual display. One or more input devices 108 (e.g., an alphanumeric keyboard, mouse, microphone, stylus pen) may be connected to the bus 103 to communicate information and commands to the computer 100. In selected embodiments, one input device 108 may provide or support control over the positioning of a cursor to allow for selection and execution of various objects, files, programs, and the like provided by the computer 100 and displayed by the display 107.

The computer 100 may be used to transmit, receive, decode, display, or the like one or more image or video files. In selected embodiments, such transmitting, receiving, decoding, and displaying may be in response to the processor 101 executing one or more sequences of one or more instructions contained in main memory 104. Such instructions may be read into main memory 104 from another non-transitory computer-readable medium (e.g., a storage device).

Execution of sequences of instructions contained in main memory 104 may cause the processor 101 to perform one or more of the procedures or steps described herein. In selected embodiments, one or more processors in a multi-processing arrangement may also be employed to execute sequences of instructions contained in main memory 104. Alternatively, or in addition thereto, firmware may be used in place of, or in connection with, software instructions to implement procedures or steps in accordance with the features and aspects disclosed herein. Thus, embodiments in accordance with the features and aspects disclosed herein may not be limited to any specific combination of hardware circuitry and software.

Non-transitory computer readable medium may refer to any medium that participates in holding instructions for execution by the processor 101, or that stores data for processing by a computer, and comprise all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, a communication interface 102 may provide or support external, two-way data communication to or via a network link. For example, a communication interface 102 may be a wireless network interface controller or a cellular radio providing a data communication network connection. Alternatively, a communication interface 102 may comprise a local area network (LAN) card providing a data communication connection to a compatible LAN. In any such embodiment, a communication interface 102 may send and receive electrical, electromagnetic, or optical signals conveying information.

A network link may provide data communication through one or more networks to other data devices (e.g., other computers, or terminals of various other types). For example, a network link may provide a connection through a local network of a host computer or to data equipment operated by an Internet Service Provider (ISP). An ISP may, in turn, provide data communication services through the Internet. Accordingly, a computer 100 may send and receive commands, data, or combinations thereof, including program code, through one or more networks, a network link, and communication interface 102. Thus, the computer 100 may interface or otherwise communicate with a remote server, or some combination thereof.

The various devices, modules, terminals, and the like discussed herein may be implemented on a computer by execution of software comprising machine instructions read from computer-readable medium, as discussed above. In certain embodiments, several hardware aspects may be implemented using a single computer, in other embodiments multiple computers, input/output systems and hardware may be used to implement the system.

For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

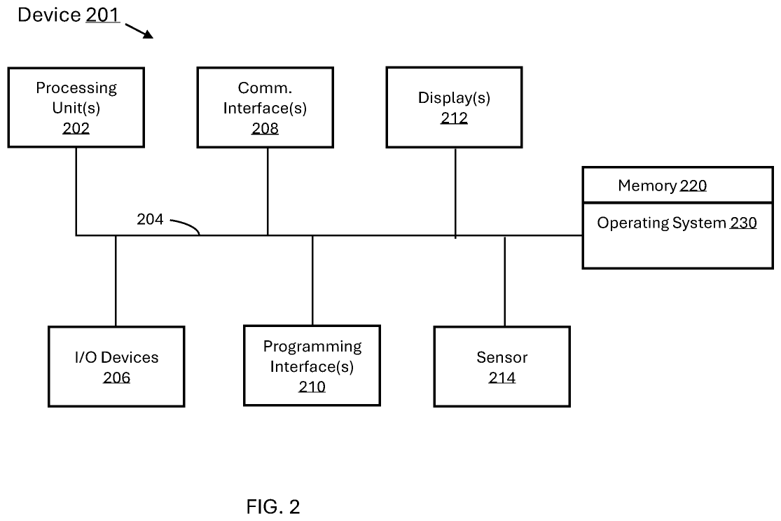

FIG. 2 is a block diagram of an example of a device 201, also referred to as an edge device, deployed device, target computing platform, or the like, in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein.

To that end, as a non-limiting example, in some implementations the edge device (in some cases implemented as the computer 100 shown in FIG. 1) or the device 201 includes one or more processing units 202 (e.g., microprocessors, ASICs, FPGAs, GPUs, CPUs, processing cores, and/or the like), one or more I/O devices and sensors 206, one or more communications interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like, type interfaces), one or more programming (e.g., I/O) interfaces 210, one or more displays 212, one or more exterior image sensors 214, a memory 220, and one or more communication buses 204 for interconnecting these and various other components.

In some implementations, the one or more communication buses 204 include circuitry that interconnects and controls communications between system components.

In some implementations, the one or more displays 212 are capable of presenting content. In some implementations, the one or more displays 212 are also configured to present flat video content to the user (e.g., a 2-dimensional or “flat” audio video interleave (AVI), flash video (FLV), Windows Media Video (WMV), or the like file associated with a TV episode or a movie, or live video pass-through of the operating environments.

In some implementations, the one or more displays 212 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro mechanical systems (MEMS), and/or the like display types. In some implementations, the one or more displays 212 correspond to diffractive, reflective, polarized, holographic, etc. waveguide displays. For example, the device 201 includes a single display. In another example, the device 201 includes a display for each eye of the user.

In some implementations, the one or more exterior image sensors 214 are configured to obtain image data frames. For example, the one or more optional exterior- and/or interior-facing image sensors 214 correspond to one or more RGB cameras (e.g., with a complementary metal-oxide-semiconductor (CMOS) image sensor, or a charge-coupled device (CCD) image sensor), infrared (IR) image sensors, event-based cameras, and/or the like.

The memory 220 includes high-speed random-access memory, such as DRAM, SRAM, DDR RAM, or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230. The optional operating system 230 includes procedures for handling various basic system services and for performing hardware dependent tasks.

It is intended that FIG. 2 is more of a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

Regarding background and notation, before aspects of this disclosure are described in more detail, background concepts and notation are described below.

### Mathematical Background

### Rings and Schemes

### Rings

The algorithm given in Guimarães operates over a circulant ring of the form [symbol] [X]/(X^{p}−1) for some prime p. Using the same notation as in Guimarães, we will refer to this ring as \tilde{R}. When the coefficients of the elements of the ring are taken modulo Q for any positive integer Q, then we will write \tilde{R}_{Q}= [symbol] [X]/(X^{p}−1). Algorithms (both in Guimarães and according to embodiments of methods disclosed herein) will also rely on power-of-two cyclotomic rings of the form [symbol] [X]/(X^{N}+1) where N=2^{k} for some k∈ [symbol] . We will denote this ring \hat{R} or \hat{R}_{Q} if taken modulo Q.

### Standard Encryption Schemes

We recall definitions and notations for the standard LWE encryption scheme used in the bootstrapping algorithms. We also extend our description to the ring version of LWE, the circulant version of LWE and GSW, all used in the algorithms.

LWE: Consider some positive integers n and q. Let sk←χ be a secret key sampled from a distribution χ, m∈ [symbol] a message, and Δ∈ [symbol] a scaling factor. The LWE encryption of the message m under the secret key sk is given by

$${LWE}_{q , sk} ( Δ \cdot m ) = [ {a}^{T} , b ] ∈ {ℤ}_{q}^{1 \times ( n + 1 )} ,$$

where

$$a ← {ℤ}_{q}^{n} , b = - a \cdot sk + e + Δ \cdot m ∈ {ℤ}_{q} , and e ← {χ}^{′}$$

is the error, sampled from a distribution χ′, and ciphertexts are represented as row vectors.

Ring LWE: The ring version of LWE considers the ring R_{q}= [symbol] [X]/(Φₘ(X)), where Φₘ is the m-th cyclotomic ring. Let sk←χ be a secret key sampled from a distribution χ, m∈R_{q}a message and Δ∈ [symbol] a scaling factor. The RLWE encryption of the message m under the secret key sk is given by

$${RLWE}_{q , sk} ( Δ \cdot m ) = [ a , b ] ∈ {R}_{q}^{1 \times 2} , where a ← {R}_{q} , b = - a \cdot sk + e + Δ \cdot$$

m and eᵢ←χ′ for each coefficient eᵢ of the error. In order to decrypt a RingLWE ciphertext, one computes the quantity b+a·sk=e+Δ·m and performs a rounding operation to recover the message m. Most schemes, including the bootstrapping algorithms considered in this disclosure, consider Φₘ(X)=X^{N}+1 for N=2^{k} and any k∈ [symbol] , and thus the RLWE problem is built with \hat{R}.

Circulant LWE: As mentioned above, the algorithm introduced in Guimarães relies on circulant rings and thus considers the hardness of a variant of LWE called circulant-LWE (CLWE). This variant was introduced and proven to be as hard as the Ring LWE variant on prime-order cyclotomic polynomials. It essentially considers the ring \tilde{R} instead of \hat{R}, and samples are obtained by considering RingLWE samples and projecting them onto \tilde{R}.

GSW: Consider a modulus q and a dimension parameter N. The GSW scheme encrypts a message m when C·v=m·v+e, where the ciphertext C is an N×N matrix over [symbol] , the secret key v is N-dimensional vector over [symbol] , and e is a small error vector. In Guimarães, the authors consider a double-CRT version of GSW, motivated by the fact that the modulus considered is quite large. More precisely, the modulus Q is decomposed into a product of smaller primes qᵢ, and CRT is used to operate independently modulo each qᵢ. Moreover, the polynomials in the ciphertexts are all represented in the FFT domain, thus the name double-CRT or RNS representation.

### Standard Operations

Modulus switching: Modulus switching is a standard operation that changes the modulus of a ciphertext. For RingLWE ciphertext, the operation takes (a, b)=RLWE_{q,sk}(Δ·m) and outputs a ciphertext (a′, b′)=RLWE_{q′,sk}(Δ·m) for a new (usually smaller) modulus q′. In Guimarães' bootstrapping algorithm, the modulus switching operation is executed on RingLWE ciphertexts only.

Key switching: Key switching is a standard operation that allows to switch of the secret key from sk to another key zk. More precisely, in the RingLWE case, it takes a ciphertext (a, b)=RLWE_{q,sk}(Δ·m) and a public key-switching key generated from the secret key sk and outputs a ciphertext (a′, b′)=RLWE_{q,zk}(Δ·m). The specific case of circulant rings defined modulo X^{p}−1 can pose some security issues. Indeed, as explained in Guimarães, it was proven that the GSW scheme over such circulant rings is secure when only encryptions of powers of X are considered. However, in key switching, one must consider the encryption of the new secret key zk, which is not a power of X. To address this, Guimarães introduces two algorithms specifically for GSW key switching with a noise-memory tradeoff.

Automorphisms: Ring automorphisms can be used to perform scalar multiplication with registers. Recall that an automorphism is a bijective map from a ring R to itself such that for a given t∈ [symbol] , we have a(X) [symbol] a(X^{t}). Previous works apply ring automorphisms on RingLWE ciphertexts. In Guimarães, automorphisms are defined over GSW ciphertexts. Consider the GSW ciphertext C defined over the ring \tilde{R}_{Q}, which encrypts a given message m under a certain key sk. We also consider a switching key akₜ. An automorphism ψₜ: \tilde{R}_{Q}→\tilde{R}_{Q} can be applied to each row of C such that ψₜ(C)∈\tilde{R}_{Q}GSW_{ψ}_{ₜ}₍ₛₖ₎ (ψₜ(m)). Applying key switching with akₜ on ψₜ(C) allows to recover a ciphertext C′∈\tilde{R}_{Q}GSW_{ψ}_{ₜ}₍ₛₖ₎ (ψ(m)).

### Incompleteness in NTT

Number-theoretic transform (NTT) has been utilized for efficient multiplication between two polynomials in a quotient ring, which is faster than other alternatives, e.g., k-way Toom-Cook, Karatsuba, and Schoolbook. Regular NTT imposes some restrictions on n and compatible modulus, which may become bottlenecks for downstream applications of NTT. There are algorithm-, software-, and hardware-based optimization tricks proposed in the literature to improve the NTT performance. One such algorithmic optimization—stopping at earlier levels when we represent the NTT operations in an iterative manner utilizing the properties of Cyclotomics and Chinese remainder theorem (CRT)—has been leveraged sporadically and in an ad-hoc manner.

A few previous works dubbed it incomplete NTT due to the fact of incomplete execution of the full NTT algorithm. In a conventional (complete) NTT-based polynomial multiplication algorithm, the input polynomials are converted from coefficient (integer) domain to value (NTT) domain, an element-wise point multiplication takes place between two NTT-domain vectors to yield the product polynomial in value (NTT) domain, and finally the product polynomial is converted from the NTT domain to the coefficient (integer) domain by inverse NTT algorithm, thus completing the polynomial multiplication algorithm. In contrast, due to the premature termination of incomplete NTT algorithms for the two input polynomials, the point-wise multiplication becomes base multiplication between two sets of small-degree polynomials. The inverse incomplete NTT also starts from the termination level and yields the final product polynomial.

Recently, Hafiz et al. formally systematized this concept—incompleteness in NTT—in the full spectrum and enlisted the benefits of it in various settings. They proposed (β′k)-layer incomplete NTT where k is the maximum number of levels possible for a full execution of the complete NTT version, and β is the number of levels executed. We introduce a new parameter, β, that presents the number of complete levels, i.e., β=k− [symbol] . We review some important definitions and theorems from the recent study.

Definition 1 (Incomplete and complete NTT). An (β′k)-layer NTT is an algorithm that stops at β out of k layers. We have k=log N and β∈[1, k]. We call an (β′k)-layer NTT a complete NTT when β=k, and an incomplete NTT when β∈[1, k−1].

Definition 2 (Incompleteness and completeness property). An (β′k)-layer NTT has β-completeness and [symbol] -incompleteness.

Theorem 1. An incomplete (β′k)-layer NTT factors the quotient polynomial

$${x}^{n} + 1 into {\prod }_{i = 0}^{{2}^{β} - 1} ( {x}^{{2}^{ℓ}} - {ζ}_{{2}^{β + 1}}^{2 \cdot {BitRev}_{β} ( i ) + 1} ) .$$

Corollary 1. For the [symbol] -incompleteness, we only require a primitive 2^{β+1}-th root of unity, i.e., ζ₂_{^{β+1}}, and a prime modulus p≡1 mod 2^{β+1}.

Theorem 2. An incomplete (β′k)-layer NTT can use a smaller p than the complete (k′k)-layer NTT counterpart.

In addition to the performance boost—due to saving the computation of β skipped layers, for both forward and inverse NTT, in exchange of cost for the base multiplication and the possibility of choosing smaller modulus (Theorem 2)—another significant advantage of inspecting incompleteness in NTT is it enables a larger set of compatible prime moduli, including smaller ones, from which a more suitable p can be chosen.

Theorem 3. Let S_{β}_{₁},S_{β}_{₂} be two sets of moduli that support (β₁′k)-layer and (β₂′k)-layer incomplete NTT, respectively. If β₁<β₂, then S_{β}_{₂}⊆S_{β}_{₁}.

For a given application, the study provides a mechanism to explore an optimal value of [symbol] and p satisfying underlying software- and hardware-level constraints, e.g., security, modular arithmetic constraints, etc. Since we can achieve better performance and a new set of flexible prime moduli through incompleteness in NTT, we investigate its application in improved amortized bootstrapping for FHEW-like schemes regarding both computation time and decryption failure rates (DFRs).

### Guimarães' Amortized Bootstrapping

The amortized bootstrapping algorithm presented in Guimarães follows the same structure as the original amortized bootstrapping algorithm introduced earlier, that is, it can be decomposed into three main steps:

Packing takes as input n LWE ciphertexts, each encrypting a (scaled) message mᵢ∈ [symbol] under the same secret key, a packing key consisting of RingLWE encryptions of coefficients of the LWE secret key and outputs a single “packed” RingLWE ciphertext encrypting a (scaled) message m(X)=ΣᵢmᵢXⁱ⁻¹. In Guimarães, the packing step is not modified from the original work.

Homomorphic decryption is the core of the algorithm and corresponds to the bootstrapping step. Homomorphically decrypting the RingLWE ciphertext obtained from packing essentially consists of computing a homomorphic polynomial multiplication as explained earlier with reference to Mathematical Background.

Message extraction is the last step of the amortized bootstrapping algorithm, where one recovers from the bootstrapped ring ciphertext the n LWE ciphertexts with reduced noise. This technique was introduced and adapted to this algorithm (in particular to the cyclic ring setup) in Guimarães.

Let us now focus on the second step, i.e., the homomorphic decryption. The output of

the previous step, the packing algorithm, is a RingLWE ciphertext

$$( a , b ) ∈ {\hat{R}}_{Q}^{2} .$$

Recall from the description of Mathematical Background that in order to (homomorphically) decrypt such a ciphertext encrypted under some key zk, one must compute the quantity b+a·zk (with an encryption of zk given as bootstrapping key). For the polynomial multiplication, Guimarães replaces the Nussbaumer transform and the SlowMult algorithm by an NTT and a pointwise multiplication. However, in order for this substitution to work, the algorithm must rely on an accumulator that enables the evaluation of a standard NTT homomorphically. This includes being able to perform operations in the exponent such as addition, subtraction, scalar multiplication, and key-switching.

The algorithm introduced in Guimarães primarily operates over the circulant ring \tilde{R}_{Q}= [symbol] [X]/(X^{p}−1) for some prime p and modulus Q, and the registers on which the homomorphic operations are performed are RingGSW ciphertexts over this ring encrypting with the secret key sk. While homomorphic multiplications and external products are common operations already well-defined for (ring) GSW, Guimarães extends the use of automorphisms and key switching to the GSW scheme of Guimarães to enable the use of the homomorphic NTT. Now, as the inputs of the polynomial multiplication are elements a, zk∈\hat{R}_{Q}, a negacyclic polynomial ring, the multiplication is done by computing

$$INTT ( NTT ( a ) \cdot NTT ( zk ) ) ≡ a \cdot zk ( mod {X}^{N} + 1 , Q ) .$$

The quantities NTT(a) and NTT(b) are first computed along with the bootstrapping keys which correspond to RingGSW encryptions of NTT(zk). The pointwise multiplication is performed using automorphisms. Finally, the inverse NTT is applied homomorphically in order to recover the GSW ciphertexts encrypting b+a·zk. The correctness of the amortized bootstrapping algorithm is given in Guimarães' Theorem 1 and the noise growth is reported in Guimarães' Corollary 2. We report in Table 1 the parameters used in both Guimarães and embodiments of this disclosure.

TABLE 1

| Type | Parameter | Description |
|---|---|---|
| Degree | N | power-of-two degree of RLWE |
| | | samples, N = 2^{k}, k ϵ N |
| | p | prime degree of |
| | | circulant-LWE samples |
| Modulus | Q | ciphertext modulus |
| Rings | [symbol] = [symbol] X]/(X^{N} + 1) | power-of-two clotomic ring |
| | [symbol] = [symbol] [X]/(X^{N} + 1) | power-of-two cyclotomic ring |
| | | with coeffients of the elements |
| | | reduced modulo Q |
| | [symbol] = [symbol] [X]/(X^{P} − 1) | circulant ring |
| | [symbol] = [symbol] [X]/(X^{P} − 1) | circulant ring with coeffients of |
| | | the elements reduced modulo Q |
| Secret | sk | RGSW secret kay in [symbol] . |
| Key | zk | RUWE secret kay in [symbol] |
| NTT- | m | radix of NTT |
| related | [symbol] | Incompleteness |
| | | degree, i.e., number of |
| | | layers that we skip in the NTT. |
| | α | balancing parameter |
| | | for the two-part NTT |

Next, we describe the inverse NTT algorithm used by Guimarães in more detail.

Two-part inverse NTT for controlling error growth

Consider the most costly operation when bootstrapping a ciphertext (a,b)∈\hat{R}_{Q} encrypted with a secret key zk, which is the homomorphic multiplication of the polynomials a and zk given an encryption of the coefficients of zk. Usually, multiplications in the cyclotomic ring \hat{R}_{Q}= [symbol] [X]/(X^{N}+1) can be done very efficiently in O(N log² N) using the fast inverse NTT (INTT), which is analogous to the in-place inverse FFT.

However, fast INTT can be problematic when using homomorphic computations due to the resulting error growth. Indeed, at each level i, for i=1 to log₂ N, the algorithm performs N/2 multiplications and N additions. While this would require only (N/2)log₂ N multiplications for cleartext operations, in the homomorphic case each INTT level requires scalar multiplications on ciphertexts, thus increasing the depth of multiplications. With resulting ciphertexts having a depth of log₂ N multiplications, their decryption will likely fail except for very small values of N.

Let us compare this to the naive INTT computation using a matrix-vector multiplication. The inverse NTT is a linear operation and thus can be described with a matrix M∈ [symbol] , so that the INTT computation now takes N² multiplications. In this case, all homomorphic multiplications are done in depth 1, and then combined with additions, making it much more manageable with respect to ciphertext error growth. However, on the downside, the large number of multiplications required can make it impractical for larger values of N.

The approach taken by Guimarães is to find a good balance between performance and depth of homomorphic multiplications (with respect to error growth). In particular, they use a two-part INTT computation based on a radix-m formulation of the INTT, which limits the homomorphic multiplication depth to only 2 levels. Algorithm 1 shows their INTT computation algorithm without considering homomorphic operations. It takes an input 0≤α≤log₂ N that defines the radix m=N/2^{α} used for the computation using Nm+N²/m=N²/2^{α}+N^{2α} operations. After a simple optimization argument, the authors conclude that using α≈(log₂ N)/2, which is the value that best balances Part 1 and Part 2 in Algorithm 1, is the optimal choice.

Algorithm 1. Two-part inverse NTT computation used by
Guimarães et al. (GPVL23].

```
  1: procedure INTT_{GPVL} (â ∈ [symbol] , α)
  2: ω ← a 2N-th root of unity of p
  3: m = N/2^{α} [symbol]    Defines the radix-m INTT computation
  4: [symbol]   Part 1: O(m(N/m)²) = O(N2^{α})
  5: for k = 0 to m - 1 do
  6: g ← (â[k] , ã[k + m], . . . , ã[N - 2m] , â[N - m])
  7: hₖ ← 0 ∈ [symbol]
  8: for j = 0 to N/m - 1 do
  $9 : {h}_{k} [ j ] ← {\sum }_{i = 0}^{N / m - 1} g [ i ] {ω}^{- 2 ij ( N / m )} mod p$
10: [symbol]   Part 2: O(m²(N/m)) = O(N²/2^{a})
11: for k₁ = 0 to N/m - 1 do
12: for k₂ = 0 to m - 1 do
13: j ← k₁ + k₂(N/m)
$14 : a [ j ] ← \frac{1}{N} {\sum }_{i = 0}^{m - 1} {h}_{i} [ {k}_{1} ] {ω}^{- j - 2 i ( {k}_{1} - {k}_{2} ( N / m ) )} mod p$
15: [symbol]   Notice that the output is in natural, not bit-reversed, order
$16 : return a ∈ {ℤ}_{p}^{N}$
17: end procedure
```

### Amortized Bootstrapping Using the Incomplete NTT

Here, we describe how to use the incomplete NTT in the context of Guimarães' amortized bootstrapping algorithm according to various aspects of this disclosure. First, we show how to define a two-part incomplete NTT whose error growth is exactly the same as that obtained by Guimarães. We then show how the base multiplication can also be integrated into the formulation without impacting the error growth. Finally, we present the remarkable property of at least one embodiment that enables us to get no performance penalty when using incompleteness levels that are not too large, which we call incompleteness for free.

### An Incomplete Formulation of the Two-Part Inverse NTT

According to at least one embodiment, one feature is to use a similar approach to the two-part inverse NTT used by Guimarães, but generalizing it to enable the use of the radix-2 incomplete NTT formulation. One challenge is that the twiddle factors are not easily defined by a closed expression in this case because there is no guarantee that a 2N-root of unity exists [symbol] .

One way to compute the twiddle factors is by considering the factorization of the inverse NTT into matrices, analogously to how other approaches considered for the FFT. If we let

$$M ∈ {ℤ}_{p}^{N \times N}$$

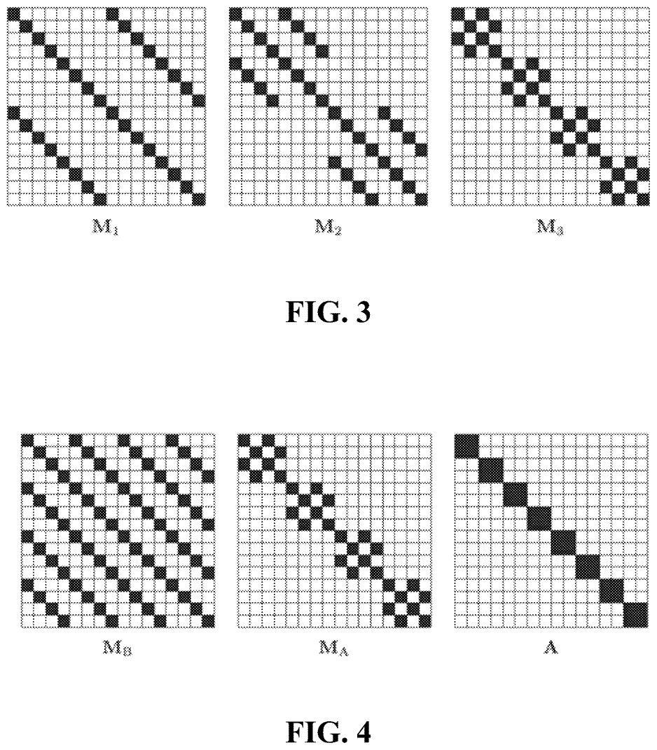

be the matrix associated with the inverse NTT operation over bit-reversed vectors, then the fast inverse incomplete NTT yields a factorization of M into

$$M = {2}^{- ( lo {g}_{2} ( N ) - ℓ )} {M}_{1} ⋯ {M}_{( lo {g}_{2} ( N ) - ℓ )} ,$$

where [symbol] is the incompleteness level, and each Mᵢ is a sparse matrix, often referred to as a butterfly matrix. FIG. 3 shows the overall shape of butterfly matrices for the particular case when N=16 and [symbol] =1.

Let α be an integer such that 0≤α≤log₂(N)− [symbol] . We can factor M into two matrices as M=M_{B}M_{A}, where M_{B}= [symbol] M₁ . . . M_{α} and M_{A}=M_{α+1} . . . M_{(log}_{₂}_{(N)-} [symbol] ₎. Since these matrices are products of the sparse butterfly matrices, they are somewhat sparse: each row of M_{B} has 2^{α} nonzero coefficients and M_{A} is a block diagonal matrix in which each block is an (N/2^{α})×(N/2^{α}) matrix. FIG. 4 shows the sparsity of M_{A} and M_{B} for N=16, [symbol] =1 and α=2.

Algorithm 2 shows how the sparsity of the matrices M_{A} and M_{B} can be used to compute the incomplete NTT in two steps according to at least one embodiment. Notice that, since N and p are part of the scheme parameters, we can easily precompute matrices M_{A} and M_{B} for the targeted level [symbol] of incompleteness. With these precomputed matrices, Algorithm 2 uses

$$O ( Nm + \frac{{N}^{2}}{m} )$$

operations and hence has the same complexity as Algorithm 1.

Algorithm 2. Two-part inverse incomplete NTT.

```
$1 : procedure {INTT}_{incomplete} ( \hat{a} ∈ {ℤ}_{p}^{N} , ℓ , α )$
  2: [symbol]   Build matrices M_{A} and M_{B} (can be precomputed for fixed
        (N, p, [symbol] , α))
  3: M ← Matrix associated with the [symbol] [symbol]    incomplete INTT of length
          N in [symbol]
  4: M₁, . . . , [symbol]  ← Butterfly matrices that factor M
  5: M_{A} ← M_{α+1} . . . M_{(log}_{₂}_{(N)-} [symbol] ₎
  6: M_{B} ← 2^{-(log}₂^{(N)-} [symbol] ⁾ M₁ . . . Mₒ
  7: m ← N/2^{α}
  8: [symbol]   Part 1: Compute a′ = M_{A} â in O(Nm) = O(N²/2^{α})
  $9 : {a}^{′} = 0 ∈ {ℤ}_{p}^{N}$
10: for j = 0 to N/m - 1 do
11: for k = 0 to m - 1 do
$12 : {a}^{′} [ jm + k ] ← {\sum }_{i = 0}^{m - 1} {M}_{A} [ jm + k ] [ i ] \cdot \hat{a} [ jm + i ]$
13: [symbol]   Part 2: Compute a = M_{B}a′ in O(N²/m) = O(N2^{α})
$14 : a = 0 ∈ {ℤ}_{p}^{N}$
15: for i = 0 to N - 1 do
16: for k = 0 to 2^{α} - 1 do
17: j ← 1 + km mod N
18: a[i] ← a[i] + M_{B}[i] [j] · a′[j]
$19 : return a ∈ {ℤ}_{p}^{N}$
20: end procedure [symbol]
indicates data missing or illegible when filed
```

Incompleteness for Free: Embedding the Basemul into Part 1

We know that the incomplete NTT provides some clear advantages compared to the complete formulation: it is faster to compute because of the reduced number of layers and enables us to use a strictly larger set of prime moduli. The only drawback is the increased complexity of the multiplication of polynomials in the incomplete NTT domain, often called the base multiplication, or basemul for short. While, in some lattice-based cryptographic schemes, the complete NTT can be slower than the incomplete NTT with [symbol] =1, the optimal level of incompleteness can depend on the scheme parameters and hardware characteristics. Interestingly, when using the two-part INTT, we noticed that the base multiplication can be embedded into the first part, i.e., the multiplication by M_{A}. Below, we show that it is possible to use the two-part INTT in a way that a small incompleteness level [symbol] can be used for fast multiplication without any performance impact.

Embedding the Base Multiplication into Part 1

Suppose we want to compute the product c=a·b of polynomials a, b∈ [symbol] [X]/(X^{N}+1), and let us assume that p and N enable the use of [symbol] -incomplete NTT. This means that the polynomial X^{N}+1 can be factored as

$${X}^{N} + 1 = {\prod }_{i = 1}^{\frac{N}{{2}^{ℓ}}} ( {X}^{{2}^{ℓ}} - {ψ}_{i} ) mod p ,$$

for a particular set of elements ψ₁, . . . , [symbol] ∈ [symbol] . In the [symbol] -incomplete NTT domain, each polynomial a and b is represented by a sequence {âᵢ} and {\hat{b}ᵢ}, respectively, for i=1 to N/ [symbol] , where âᵢ, \hat{b}ᵢ∈ [symbol] [X]/( [symbol] −ψᵢ). In this case, the base multiplications correspond to the computations of the products ĉᵢ=âᵢ·\hat{b}ᵢ for all i. The product polynomial can then be computed using the inverse NTT as c=INTT(ĉ₁, ĉ₂, . . . , [symbol] ).

Since we use the two-part inverse NTT based on matrix-vector multiplications in the amortized bootstrapping application according to at least embodiment, let us put the base multiplications in the same form. The base multiplication is typically done using a naive schoolbook multiplication algorithm as it is often the best choice for small values of [symbol] . Notice that the schoolbook multiplication of polynomials âᵢ, \hat{b}ᵢ∈ [symbol] [X]/( [symbol] −ψᵢ) can be easily represented in the matrix-vector form as follows. Let

$${\hat{c}}_{i} = {\hat{a}}_{i} \cdot {\hat{b}}_{i} and let {\hat{a}}_{i} , {\hat{b}}_{i} , {\hat{c}}_{i} ∈ {ℤ}_{p}^{{2}^{ℓ}}$$

be the vectors of coefficients of âᵢ, \hat{b}ᵢ, and ĉᵢ, respectively. Then, ĉᵢ=Aᵢ\hat{b}ᵢ, where

$${A}_{i} = ( \begin{matrix}{\hat{a}}_{i} [ 0 ] & {\hat{a}}_{i} [ n - 1 ] {ψ}_{i} & ⋯ & {\hat{a}}_{i} [ 1 ] {ψ}_{i} \\ {\hat{a}}_{i} [ 1 ] & {\hat{a}}_{i} [ 0 ] & ⋯ & {\hat{a}}_{i} [ 2 ] {ψ}_{i} \\ ⋮ & ⋮ & ⋱ & ⋮ \\ {\hat{a}}_{i} [ n - 1 ] & {\hat{a}}_{i} [ n - 2 ] & ⋯ & {\hat{a}}_{i} [ 0 ]\end{matrix} ) ∈ {ℤ}_{p}^{{2}^{ℓ} \times {2}^{ℓ}} .$$

If we choose parameter α in 0≤α≤log₂ N− [symbol] , we can define the two-part INTT matrices M_{B} and M_{A} as discussed previously. Furthermore, define the block diagonal matrix A as

$$A = ( \begin{matrix}{A}_{1} & & & 0 \\ & & & \\ & & ⋱ & \\ 0 & & & {A}_{\frac{N}{{2}^{ℓ}}}\end{matrix} ) ∈ {ℤ}_{p}^{N} .$$

Then, if c∈ [symbol] is the vector of coefficients of the product c=a·b, we obtain the matrix description of the inverse NTT as c=M_{B}M_{A}A\hat{b}.

Notice that M_{A}A is a product of two block diagonal matrices, where the square blocks in M_{A} and A have size (N/2^{α}) and [symbol] , respectively, as illustrated in FIG. 4. Since N is a power of 2, both dimensions are also powers of 2, which means M_{A}A is also a block matrix with square blocks of size max(N/2^{α}, [symbol] ). However, since α≤log₂ N− [symbol] , then max(N/2^{α}, [symbol] )=N/2^{α}. Therefore, if X=M_{A}A, the computation of the matrix-vector product Xy has exactly the same complexity as computing M_{A}Y, for an arbitrary vector y. We then say that matrix X embeds the base multiplication into the first part of the two-part INTT.

### Incompleteness for Free.

Suppose we use the complete NTT formulation for a prime p and a power-of-two N, and let us assume α* is the balancing factor that yields the Tt operation count for the two-part INTT. Let p′ be a prime for which we can use the [symbol] -incomplete negacyclic NTT for polynomials in [symbol] [X]/(X^{N}+1). Then, as long as [symbol] ≤log₂ N−α*, if we use the two-part INTT with embedding of the base multiplication, the operation count for these two procedures is the same:
computing the pointwise product between two vectors in the NTT domain followed by the complete INTT for fast multiplication in [symbol] [X]/(X^{N}+1);
computing the base multiplication of vectors in the [symbol] -incomplete NTT domain followed by the incomplete INTT for fast multiplication in [symbol] [X](X^{N}+1)

According to at least one aspect, this observation enables us to leverage incompleteness to use smaller primes. While on one hand, the number of operations is the same even when using smaller primes—on the other hand, operations modulo smaller primes can be processed faster when using homomorphic operations.

### Homomorphic Polynomial Multiplication Using the Incomplete NTT

We now give a full description of the homomorphic implementation of our multiplication algorithm according to at least one embodiment. To do that, we use the homomorphic dot product presented in Guimarães Algorithm 7 as a building block. This function, denoted as homomorphic_dot_product, uses the encryption Kₛₖ of the secret key sk, which we recall is the secret key used for the \tilde{R}_{Q}GSW encryptions, and the set of key-switching keys

$${( {K}_{v} )}_{v = 0}^{p - 1}$$

together with automorphisms to compute the dot product between an unencrypted vector

$$u ∈ {ℤ}_{p}^{k}$$

and an encrypted vector m∈

$${ℤ}_{p}^{k} .$$

### Concretely, if

$$m , u ∈ {ℤ}_{p}^{k}$$

and each Cᵢ encrypts X^{m[i]}, then

$${C}^{′} ← homomorphic\_dot \_product ( {( {C}_{i} )}_{i = 1}^{k} , u , {K}_{s k} , {( {K}_{v} )}_{v = 0}^{p - 1} )$$

results in an encryption C′ of X^{<u,m>}.

Algorithm 3. Homomorphic polynomial multiplication using the two-part
incomplete INTT formulation. This function caan be plugged into the partial
decryption function defined in the GPVL algorithm [GPVL23, Algorithm 9].

```
  $1 : procedure homomorphic\_polymul ( a ∈ {\hat{ℛ}}_{p} , \{ {Z}_{i} \} , {K}_{sk} , {( {K}_{v} )}_{v = 0}^{p - 1} , ℓ ∈ ℤ , α ∈ ℤ )$
  $2 : ⊳ zk = {( {Z}_{i} )}_{i = 0}^{N - 1} is the bootstrapping key , where {Z}_{i} ∈ \text{?} {GSW}_{sk} ( {X}^{- \hat{z} [ i ]} )$
  3: [symbol]   Kₛₖ ∈ [symbol]  GSWₛₖ (-sk)
  4: [symbol]   Kᵥ ∈ [symbol]  KSₛₖ (sk(X [symbol]  )) is a key-switching key for the automorphism
X [symbol]  X [symbol]
  5: [symbol]   Build matrice M_{A} and M_{B} (can be precomputed for fixed (N, p, [symbol] ,o))
  6: M ← Matrix associated with the [symbol] -incomplete INTT of length N in [symbol]
  7: M₁, . . . , [symbol]   ← Butterfly matrices that factor M
  8: M_{A} ← Mₐ₊₁ . . . M_{(log}_{₂}_{(N)-} [symbol] ₎
  9: M_{B} ← 2^{-(log}₂^{(N)-} [symbol] ⁾M₁ . . . M_{α}
10: [symbol]   Build matrix X embedding the base multiplication by â into M_{A}
$11 : \hat{a} ← NTT ( a ) ∈ {ℤ}_{p}^{N}$
12: A ← block matrix representing the base multiplication by â
13: X ← M_{A}A
14: [symbol]   No homomorphic operations used yet, so all code above has negligible impact
15: [symbol]   Part 1: Homomorphic computation X\hat{z} in O(N²/2^{α})
16: for i = 0 to N - 1 do
$17 \text{:} {C}^{′} [ i ] ← homomorphic\_dot \_product ( {Z}_{i} , X [ i ] , {K}_{sk} , {( {K}_{v} )}_{v = 0}^{p - 1} )$
18: [symbol]   Part 2: Homomorphic computation of M_{B} (X\hat{z}) in O(N2^{α})
19: for i = 0 to N - 1 do
$20 \text{:} {C}_{i} ← homomorphic\_dot \_product ( {( {C}_{i}^{′} )}_{i = 0}^{N - 1} , {M}_{B} [ i ] , {K}_{sk} , {( {K}_{v} )}_{v = 0}^{p - 1} )$
$21 : return {( C )}_{i = 0}^{N - 1} \text{?} Each {C}_{i} ∈ \text{?} {GSW}_{sk} ( X \text{?} )$
22: end procedure [symbol]
indicates data missing or illegible when filed
```

Algorithm 3 shows the homomorphic implementation of the polynomial multiplication using the two-part [symbol] -incomplete NTT according to at least one embodiment. The algorithm homomorphically multiplies the polynomial a∈\hat{R}_{P} by an encrypted polynomial zk as follows. More precisely, the core inputs are the polynomial a∈\hat{R}ₚ and the GSW encryptions Zᵢ of each coefficient \hat{z}[i] of the NTT representation of the polynomial zk∈\hat{R}ₚ. It also receives the encryption Kₛₖ of the secret key sk, and a set {Kᵥ} of key-switching keys, used to perform the dot products. The last parameters are the incompleteness parameter e and the balancing parameter a, which define the two-part incomplete NTT.

The algorithm begins by performing some non-homomorphic operations, which have negligible cost compared to the homomorphic ones. First, it computes the auxiliary matrices M_{A} and M_{B} and the base multiplication embedding matrix X. Then it performs two rounds of homomorphic dot products, first for the multiplication by X, then for the multiplication by M_{B}. Each element Cᵢ from the output (C₀, . . . , C_{N-1}) consists of the encryption of X^{c}^{ᵢ}, where cᵢ is the i-th coefficient of the polynomial product a·z.

### Bootstrapping Algorithm

We present our amortized bootstrapping algorithm according to at least one embodiment in Algorithm 4, where a key distinction relative to the structure of Guimarães is with regards to the homomorphic decryption procedure. In the last procedure, NTTDecModified, the homomorphic polynomial multiplication is executed with our Algorithm 3.

Algorithm 4. Amortized bootstrapping algorithm for message space [symbol] .

```
  1: procedure Bootstrap(Input)
  $2 : Input : {c}_{i} ∈ {LWE}_{s}^{Q} ( Δ \cdot {m}_{i} ) ∈ {ℤ}^{p + 1} for 0 \leq i < N and Δ = [ Q / t ]$
  3: fᵢ : [symbol]   → [symbol]
  4: Bootstrapping key zk
  5: Key-switching keys Kᵥ
  6: (a, b) ← PackLWE (c₀, . . . , c_{N-1})
  7: (a′, b′) ← ModSwitch_{Q ←} ₚ (a, b)
  8: (C₀, . . . , C_{N-1}) = NTTDecModified (a′, b′)
  9: for i = 0 to N - 1 do
$10 : {c}_{i}^{′} = MsgExtract ( {C}_{i} , {f}_{i} )$
$11 : return {c}_{0}^{′} , … , {c}_{N - 1}^{′}$
12: end procedure
```

We now provide an analysis of the cost and correctness of our algorithm according to at least one embodiment.

### Theorem 4 (Cost of the Bootstrapping Algorithm).

Let

$$Q = {\prod }_{i = 1}^{t} {q}_{i}$$

be the ciphertext modulus and d be the number of CRT digits used in the GSW ciphertexts. Given at most n LWE ciphertexts and the relevant bootstrapping keys, Algorithm 4 outputs LWE ciphertexts at the cost of O(N^{1+1/ρ}·ρ·d²·t) NTTs and O(N^{1+1/ρ}·ρ·d·t²·p) multiplications in

$${ℤ}_{{q}_{i}} , where ρ = \frac{1}{1 - α log 2 / log N} .$$

Proof. In Guimarães, the radix m is set to m=N^{1/ρ} where ρ is the recursive depth of the bootstrapping algorithm. In our work, we set

$$m = \frac{N}{{2}^{α}} , thus ρ = \frac{1}{1 - α log 2 / log N} .$$

The overall cost of Algorithm 4 is asymptotically dominated by the cost of NTTDecModified. As mentioned above, NTTDecModified has the same complexity as NTTDec and thus the overall complexity of the algorithm remains the same as in Guimarães.

### Theorem 5 (Correctness of Bootstrapping)

For a security parameter λ, let Q=Õ(λ^{2.5+ρ}) and consider that the input ciphertexts

$${c}_{i} ∈ {LWE}_{s}^{Q} ( Δ \cdot {m}_{i} , {E}^{( i n )} ) ∈ {ℤ}_{p}^{+ 1} satisfy {E}^{( i n )} = O ( Q / λ ) .$$

Then, with probability 1−2^{-λ}, the output of Algorithm 4 is correct, i.e., it outputs valid LWE encryptions of f(mᵢ), with E′−subgaussian noise, where Õ(λ^{1.5+ρ})=Õ(Q/λ), thus, it is composable.

### Implementation Aspects and Experimental Results

### Implementation

Implementation of at least one embodiment is built on the code provided by Guimarães, which uses the Intel HEXL library to speedup some of the mathematical computations. While HEXL comes with efficient vectorized implementations for number-theory related functions and multiplications in polynomial rings, Guimarães made some necessary adjustments to their code to be able to use HEXL for their purposes. For example, some of the most costly operations during bootstrapping take place inside the ring \tilde{R}′= [symbol] [X]/(X^{p}−1), but HEXL is optimized for fast NTT-based multiplication over rings of the form \tilde{R}′= [symbol] [X]/(X^{N′}−1), where N′ is a power of two (recall that p is a prime).

In order to use HEXL for operations in \tilde{R}, they then notice that a product a·b of polynomials a, b∈\tilde{R} has degree at most 2p−2. Hence, if they consider N′ as the first power of two larger than 2p−2, and represent the polynomials a and b as elements in \tilde{R}′, the resulting product in \tilde{R}′ would be efficiently computed in HEXL and will not be reduced modulo (X^{N′}−1). Therefore, by manually reducing the result by (X^{p}−1), they can obtain the desired product a·b∈\tilde{R}.

The drawback of this approach is that memory usage and element-wise operations take roughly 2× more when operating in \tilde{R}′ instead of \tilde{R} directly. They conclude that one should choose p as close to the next power of two as possible, which can be explained for two reasons. First, the bootstrapping performance is very similar for values of p with the same number of bits. Second, the LWE hardness and DFR are better when p is larger.

According to at least one aspect, these observations can be seen as a main motivation for using the incomplete NTT for free as described earlier with reference to various embodiments. Indeed, such embodiments allow using optimal values of p without any compromise in performance, so that we can either achieve faster and secure instantiations (by reducing the bit size of p) or significantly reduce the DFR (by increasing p within the same bit size). These benefits are described in more detail below.

### Benefits of Incompleteness for Faster Bootstrapping and Lower DFR

For a given prime modulus p, the proposed algorithm according to at least one embodiment allows for four layers of incompleteness at (essentially) no additional computational cost, i.e., [symbol] =4, compared to the complete NTT, where β=k=10 or [symbol] =0. According to Corollary 1, this approach requires only a primitive 2⁷-th root of unity and a modulus satisfying p ≡1 mod 2⁷, instead of a 2¹¹-th root of unity and a modulus satisfying p ≡1 mod 2¹¹. Consequently, the minimum prime modulus required for a 4-layer incomplete NTT is 257, which is significantly smaller than the 12,289 required for the complete NTT, in alignment with Theorem 2.

Furthermore, the set of prime moduli available for a 4-layer incomplete NTT is larger than that for a complete NTT, as stated in Theorem 3. Specifically, the cardinality of the set of primes satisfying 4-layer incompleteness is greater than that of those satisfying 10-layer completeness, i.e., |S₆|>|S₁₀|. For instance, in the case of a 13-bit prime modulus, where 2¹²<p<2¹³, the set of compatible primes for 4-layer incompleteness is given by

$${S}_{6}^{13} = \{ 4481 , 4993 , 6529 , 7297 , 7681 , 7937 \} .$$

In contrast, for a complete NTT, the set of compatible 13-bit primes is empty, i.e.,

$${S}_{10}^{13} = ∅ ,$$

indicating that no 13-bit prime satisfies the complete NTT requirement. Similarly, for a 14-bit prime modulus, the set of primes supported by 4-layer incompleteness is given by

$${S}_{6}^{14} = \{ 9473 , … , 12289 , … , 15361 , 16001 \} ,$$

whereas for the full completeness, the corresponding set consists of a single element,

$${S}_{10}^{14} = \{ 12289 \} .$$

For improved performance and minimized DFR considerations, primes closer to the corresponding power-of-two values, such as 8192 and 16,384 for 13-bit and 14-bit cases, respectively, are of our particular interest. In our evaluation, we focus on the primes 7681, 7937, 15,361, and 16,001, as they are closest to these boundaries and provide a balance between efficiency and security.

### Experimental Results

We test our algorithm according to at least one embodiment with different sets of parameters varying the ring size N, the prime modulus p, the size of p*, and the hamming weight of the secret key. We run all our experiments on the same machine using an Intel Xeon Platinum 8260 CPU at 2.4 GHz with 250 GB of RAM, running Ubuntu 20.04.6 LTS, and report results for single-threaded executions. All the parameter sets considered achieve at least a 128-bit security level based on the LWE estimator. We report our results in Table 2, where both amortized execution time (in milliseconds) and decryption failure rates are averaged over XX experiments. The first line of Table 2 shows the parameters and results obtained using Guimarães' code with no modifications. Table 2 shows parameter sets offering different tradeoffs between performance and decryption failure rate. All of these parameters satisfy a 128-bit security level. We report numbers for 8-bit messages. In our case, we use 4-incompletness for all experiments, as it comes for free. All experiments are single-threaded.

TABLE 2

| | | | log₂ | Key | | Amortized | |
|---|---|---|---|---|---|---|---|
| Algorithm | N | p | (p*) | HW | DFR | time (ms) | Speedup |
| [GPVL23] | 1024 | 12289 | 24 | 256 | 2^{-17.3} | 1,255.5 | — |
| | 1024 | 7681 | 24 | 256 | 2^{-8.8} | 589.30 | 2.13× |
| | 1024 | 7937 | 24 | 256 | 2^{-9.3} | 687.71 | 2.14× |
| | 1024 | 16001 | 24 | 256 | 2^{-24.1} | 1,280.41 | 0,98× |
| Ours | 2048 | 7681 | 27 | 52 | 2^{-39.3} | 881.67 | 1.42× |
| | 2048 | 7937 | 27 | 52 | 2^{-41.5} | 893.76 | 1.41× |
| | 2048 | 12289 | 27 | 52 | 2^{-90.2} | 1,889.88 | 0.66× |
| | 2048 | 16361 | 27 | 52 | 2^{-131.9} | 1,906.12 | 0.65× |

With the flexibility of incompleteness, we are able to lower the modulus p to 7937 and obtain a much improved amortized time of 587 ms for N=1024. This results in a 2.14× speedup compared to Guimarães. However, in this case, our DFR is much worse than in the original work and as high as 2⁻⁹. In order to improve upon the DFR while still maintaining good timings, we increase the ring size to N=2048. In this case, we are able to decrease the DFR significantly to 2⁻³⁹ while still improving on the amortized time for p=7681. More precisely, we obtain an amortized time of 881 ms, corresponding to a 1.42× speedup compared to Guimarães.

Overall, Table 2 showcases an interesting tradeoff between the execution time of our algorithm according to at least one embodiment and the observed DFRs. Indeed, as we are able to explore a wide range of modulus values p, we can significantly lower the execution time of the algorithm by considering much smaller primes, however, at the cost of a high DFR, but also significantly lower the DFR by increasing the prime modulus p. For both N=1024 and N=2048, by choosing p larger than the original modulus 12289, we are able to improve the DFR of Guimarães with only a small effect on performance. More precisely, by choosing p=16001 and p=15361 for N=1024 and N=2048 respectively, we obtain DFR values of 2⁻²⁴ and 2⁻¹³¹ (while the original algorithm obtains 2⁻¹⁷ for 8-bit messages) while the performance drops by 2% and 35% respectively. In the case of N=2048 and p=15361, we even obtain a better DFR than the 2⁻¹²⁸ failure probability guaranteed by TFHE-rs v1.0.

Comparison with State-of-the-Art

In addition to the improvement over Guimarães already reported in Table 2, we compare our algorithm according to at least one embodiment with its sequential counterpart for programmable bootstrapping, namely TFHE-rs latest version v1.0. In Table 3, we report the amortized cost in milliseconds. Similarly to before, the experiments were all run on the same machine with single-threaded executions. For our algorithm, we provide two timings: our fastest time using N=1024 but where the DFR is high (2⁻⁹ as reported in Table 2) and our fastest time for N=2048 where the increased ring size allows us to lower the DFR significantly (2⁻³⁹ as reported in Table 2) while still achieving better time than Guimarães. Table 3 shows comparison with state-of-the-art implementations of sequential and amortized bootstrapping algorithms. For TFHE-rs, we run pbs128-bench and average over 10 experiments. All experiments are single-threaded.

TABLE 3

| | | | LWE | Time per | Number of |
|---|---|---|---|---|---|
| | | | secret | LWE | ciphertexts |
| | | | key | ciphertext | per |
| | Algorithm | Source | type | (ms) | bootstrapping |
| Sequential | TFHE PBS | TFHE-rs | Binary | 660 ms | 1 |
| | [GPVL23] | Code | Ternary | 1,255.5 | 1024 |
| Amortized | Ours | Code | Ternary | 587.7 | 1024 |
| | | | | 881.7 | 2048 |

For the sequential algorithm benchmarks, the only implementation for programmable (or functional) bootstrapping is TFHE-rs with a running time of 660 ms, which is only 1.33× faster than our timing with reasonable DFR, i.e., 2⁻³⁹. Our best time is actually 1.12× faster than TFHE-rs (ignoring the high DFR).

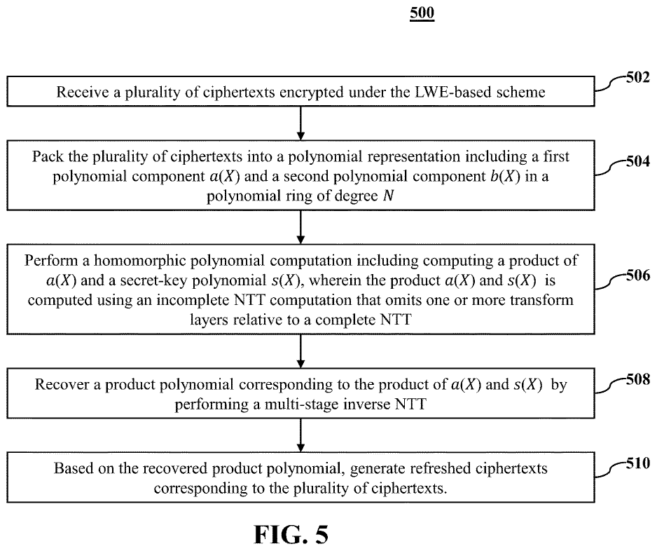

FIG. 5 illustrates a flowchart of a method 500 for performing amortized bootstrapping of ciphertexts in a learning-with-errors (LWE)-based fully homomorphic encryption (FHE) scheme using incomplete number theoretic transforms according to at least one embodiment.

At block 502, a plurality of ciphertexts encrypted under an LWE-based cryptographic scheme are received.

For example, as described earlier regarding amortized bootstrapping presented by Guimarães, an input of n LWE ciphertexts each encrypting a (scaled) message is received.

At block 504, the plurality of ciphertexts are packed into a polynomial representation including at least a first polynomial component (X) and a second polynomial component b(X) in a polynomial ring of degree N.

According to a further embodiment, packing the plurality of ciphertexts into the polynomial representation comprises packing the plurality of ciphertext into a ring-learning-with-errors (RLWE) ciphertext including the first polynomial component a(X) and the second polynomial component b(X).

For example, as described earlier regarding amortized bootstrapping presented by Guimarães, n LWE input ciphertexts are packed to output a RingLWE ciphertext

$$( a , b ) ∈ {\hat{R}}_{Q}^{2} .$$

At block 506, a homomorphic polynomial computation is performed. Performing the computation includes computing a product of a polynomial component a(X) of the polynomial representation and a secret-key polynomial s(X). The product a(X) and s(X) is computed using an incomplete NTT computation that omits one or more transform layers relative to a complete NTT.

For example, as described earlier with reference to Algorithm 3, a homomorphic implementation of the polynomial multiplication using a two-part [symbol] -incomplete NTT.

According to a further embodiment, the incomplete NTT computation performs log₂(N)− [symbol] transform layers of a radix-2 NTT algorithm, wherein [symbol] denotes a number of the omitted one or more transform layers.

A modulus p used for the polynomial ring may be selected to satisfy

$$p ≡ 1 ( mod ( \frac{2 N}{{2}^{ℓ}} ) )$$

to enable the incomplete NTT.

According to a further embodiment, the secret-key polynomial s(X) corresponds to a secret key used for decrypting a ring-learning-with-errors (RLWE) ciphertext.

At block 508, a product polynomial corresponding to the product a(X) and s(X) is recovered by performing a multi-stage inverse NTT. The multi-stage inverse NTT includes: a first stage that performs inverse transform operations and integrates multiplication of transform-domain coefficients corresponding to a(X) and s(X); and a second stage that completes recovery of the product polynomial.

For example, as described earlier with reference to Algorithm 3, a two-part incomplete inverse NTT formulation involves embedding of a base multiplication into part 1.

According to a further embodiment, the multiplication of the transform-domain coefficients corresponding to a(X) and s(X) is integrated with the inverse transform operations within the first stage of the multi-stage inverse NTT.

According to a further embodiment, the multiplication of the transform-domain coefficients corresponding to a(X) and s(X) after the forward transform is performed by integrating the transform-domain multiplication into the multi-stage inverse NTT.

According to a further embodiment, the multi-stage inverse NTT includes a two-part inverse NTT including: the first stage that performs partial inverse transform operations and multiplication of the transform-domain coefficients corresponding to a(X) and s(X); and the second stage that completes recovery of the product polynomial.

According to a further embodiment, the omission of the one or more transform layers is enabled without increasing computational complexity of computing the product of a(X) and s(X) relative to the complete NTT.

For example, as described earlier with reference to incompleteness for free, using the two-part INTT with embedding of the base multiplication does not increase operation count relative to computing the pointwise product between two vectors in the NTT domain followed by the complete INTT.

At block 510, refreshed ciphertexts corresponding to the plurality of ciphertexts are generated based on the recovered product polynomial.

For example, as described earlier with reference to amortized bootstrapping algorithms, are a way to refresh multiple ciphertexts at once, e.g., after polynomial-domain computation.

According to a further embodiment, generating the refreshed ciphertexts based on the recovered product polynomial includes generating a plurality of LWE ciphertexts corresponding to the plurality of received ciphertexts.

For example, as described earlier with reference to message extraction, n LWE ciphertexts with reduced noise are recovered from the bootstrapped ring ciphertext.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first image could be termed a second image, and, similarly, a second image could be termed a first image, which changing the meaning of the description, so long as the occurrences of the “first image” are renamed consistently and the occurrences of the “second image” are renamed consistently. The first image and the second image are both images, but they are not the same image.

The terminology used herein is for the purpose of describing particular implementations only and is not intended to be limiting of the claims. As used in the description of the implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The present disclosure is not limited to what has been described above, and other aspects and advantages of the present disclosure not mentioned above will be understood through the following description of embodiments of the present disclosure. Further, it will be understood that the aspects and advantages of the present disclosure may be achieved by the configurations described in claims and combinations thereof.

In accordance with some implementations, an electronic device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of an electronic device, cause the electronic device to perform or cause performance of any of the methods described herein. In accordance with some implementations, an electronic device includes: one or more processors, a non-transitory memory, and means for performing or causing performance of any of the methods described herein.

What is claimed is:

1. A computer-implemented method for performing amortized bootstrapping of ciphertexts in a learning-with-errors (LWE)-based fully homomorphic encryption (FHE) scheme using incomplete number theoretic transforms (NTTs), the method comprising:
receiving a plurality of ciphertexts encrypted under a LWE-based scheme;
packing the plurality of ciphertexts into a polynomial representation comprising a first polynomial component a(X) and a second polynomial component b(X) in a polynomial ring of degree N;
performing a homomorphic polynomial computation comprising computing a product of a(X) and a secret-key polynomial s(X),
wherein the product of a(X) and s(X) is computed using an incomplete NTT computation that omits one or more transform layers relative to a complete NTT;
recovering a product polynomial corresponding to the product of a(X) and s(X) by performing a multi-stage inverse NTT comprising:
a first stage that performs inverse transform operations and integrates multiplication of transform-domain coefficients corresponding to a(X) and s(X); and
a second stage that completes recovery of the product polynomial; and
based on the recovered product polynomial, generating refreshed ciphertexts corresponding to the plurality of ciphertexts.

2. The method of claim 1, wherein the incomplete NTT computation performs log₂(N)− [symbol] transform layers of a radix-2 NTT algorithm, wherein [symbol] denotes a number of the omitted one or more transform layers.

3. The method of claim 2, wherein a modulus p used for the polynomial ring is selected to satisfy
$$p ≡ 1 ( mod ( \frac{2 N}{{2}^{ℓ}} ) )$$
to enable the incomplete NTT.

4. The method of claim 1, wherein the multiplication of the transform-domain coefficients corresponding to a(X) and s(X) is integrated with the inverse transform operations within the first stage of the multi-stage inverse NTT.

5. The method of claim 1, wherein the multiplication of the transform-domain coefficients corresponding to a(X) and s(X) after a forward transform is performed by integrating the transform-domain multiplication into the multi-stage inverse NTT.

6. The method of claim 1, wherein the multi-stage inverse NTT comprises a two-part inverse NTT including:
the first stage that performs partial inverse transform operations and multiplication of the transform-domain coefficients corresponding to a(X) and s(X); and
the second stage that completes recovery of the product polynomial.

7. The method of claim 1, wherein the omission of the one or more transform layers is enabled without increasing computational complexity of computing the product of a(X) and s(X) relative to the complete NTT.

8. The method of claim 1, wherein generating the refreshed ciphertexts based on the recovered product polynomial comprises generating a plurality of LWE ciphertexts corresponding to the plurality of received ciphertexts.

9. The method of claim 1, wherein packing the plurality of ciphertexts into the polynomial representation comprises packing the plurality of ciphertext into a ring-learning-with-errors (RLWE) ciphertext including the first polynomial component a(X) and the second polynomial component b(X).

10. The method of claim 1, wherein the secret-key polynomial s(X) corresponds to a secret key used for decrypting a ring-learning-with-errors (RLWE) ciphertext.

11. A non-transitory computer-readable medium storing instructions for performing amortized bootstrapping of ciphertexts in a learning-with-errors (LWE)-based fully homomorphic encryption (FHE) scheme using incomplete number theoretic transforms (NTTs), that, when executed by a processor of a computing device, cause the computing device to:
receive a plurality of ciphertexts encrypted under a LWE-based scheme;
pack the plurality of ciphertexts into a polynomial representation comprising a first polynomial component a(X) and a second polynomial component b(X) in a polynomial ring of degree N;
perform a homomorphic polynomial computation comprising computing a product of a(X) and a secret-key polynomial s(X),
wherein the product of a(X) and s(X) is computed using an incomplete NTT computation that omits one or more transform layers relative to a complete NTT;
recover a product polynomial corresponding to the product of a(X) and s(X) by performing a multi-stage inverse NTT comprising:
a first stage that performs inverse transform operations and integrates multiplication of transform-domain coefficients corresponding to a(X) and s(X); and
a second stage that completes recovery of the product polynomial; and
based on the recovered product polynomial, generate refreshed ciphertexts corresponding to the plurality of ciphertexts.

12. The non-transitory computer-readable medium of claim 11, wherein the incomplete NTT computation performs log₂(N)− [symbol] transform layers of a radix-2 NTT algorithm, wherein [symbol] denotes a number of the omitted one or more transform layers.

13. The non-transitory computer-readable medium of claim 12, wherein a modulus p used for the polynomial ring is selected to satisfy
$$p ≡ 1 ( mod ( \frac{2 N}{{2}^{ℓ}} ) )$$
to enable the incomplete NTT.

14. The non-transitory computer-readable medium of claim 11, wherein the multiplication of the transform-domain coefficients corresponding to a(X) and s(X) is integrated with the inverse transform operations within the first stage of the multi-stage inverse NTT.

15. The non-transitory computer-readable medium of claim 11, wherein the multiplication of the transform-domain coefficients corresponding to a(X) and s(X) after a forward transform is performed by integrating the transform-domain multiplication into the multi-stage inverse NTT.

16. The non-transitory computer-readable medium of claim 11, wherein the multi-stage inverse NTT comprises a two-part inverse NTT including:
the first stage that performs partial inverse transform operations and multiplication of the transform-domain coefficients corresponding to a(X) and s(X); and
the second stage that completes recovery of the product polynomial.

17. The non-transitory computer-readable medium of claim 11, wherein the omission of the one or more transform layers is enabled without increasing computational complexity of computing the product of a(X) and s(X) relative to the complete NTT.

18. The non-transitory computer-readable medium of claim 11, wherein, when executed by the processor, the instructions further cause the computing device to generate the refreshed ciphertexts based on the recovered product polynomial by generating a plurality of LWE ciphertexts corresponding to the plurality of received ciphertexts.

19. The non-transitory computer-readable medium of claim 11, wherein, when executed by the processor, the instructions further cause the computing device to pack the plurality of ciphertexts into the polynomial representation by packing the plurality of ciphertext into a ring-learning-with-errors (RLWE) ciphertext including the first polynomial component a(X) and the second polynomial component b(X).

20. A system for performing amortized bootstrapping of ciphertexts in a learning-with-errors (LWE)-based fully homomorphic encryption (FHE) scheme using incomplete number theoretic transforms (NTTs), the system comprising:
one or more processors; and
a memory storing instructions that, when executed by the one or more processors cause the system to:
receive a plurality of ciphertexts encrypted under a LWE-based scheme;
pack the plurality of ciphertexts into a polynomial representation comprising a first polynomial component a(X) and a second polynomial component b(X) in a polynomial ring of degree N;
perform a homomorphic polynomial computation comprising computing a product of a(X) and a secret-key polynomial s(X),
wherein the product of a(X) and s(X) is computed using an incomplete NTT computation that omits one or more transform layers relative to a complete NTT;
recover a product polynomial corresponding to the product of a(X) and s(X) by performing a multi-stage inverse NTT comprising:
a first stage that performs inverse transform operations and integrates multiplication of transform-domain coefficients corresponding to a(X) and s(X); and
a second stage that completes recovery of the product polynomial; and
based on the recovered product polynomial, generate refreshed ciphertexts corresponding to the plurality of ciphertexts.
